(19) United States
(12) Patent Application Publication
(10) Pub. No.: US 2024/0202774 A1
(43) Pub. Date: Jun. 20, 2024

(54) APPARATUS FOR DETERMINING AN OUTPUT IN DEPENDENCE ON AN AUDIENCE

(71) Applicant: NumberEight Technologies Ltd, Norwich (GB)

(72) Inventors: Abhishek Sen, Norwich (GB); Christopher John Watts, Norwich (GB); Hector Durham, Norwich (GB); Eoin Robert Groat, Norwich (GB); Vincent Paul Frank Groff, Norwich (GB)

(21) Appl. No.: 18/286,363

(22) PCT Filed: Apr. 12, 2022
(86) PCT No.: PCT/GB2022/050919

§ 371 Date: Oct. 10, 2023

(30) Foreign Application Priority Data
Apr. 12, 2021 (WO) PCT/GB2021/050886

(51) Int. Cl. G06Q 30/0251

(52) U.S. Cl. CPC G06Q 30/0255; G06Q 30/0252; G06Q 30/0261

(57) ABSTRACT

An apparatus is provided for determining an output based on a membership of the user in an audience. The apparatus includes a processor for determining a threshold associated with membership of an audience, determining a score relating to a user in dependence on one or more activities of the user associated with the audience wherein at least one activity is determined based on contextual information of the user, and determining the membership of the user in the audience in dependence on whether the score exceeds the threshold. Also included is a user interface and/or a communication interface for providing an output for the user based on the membership of the user in the audience.

### FIELD OF THE INVENTION

The present invention relates to an apparatus for determining an output for a user based on a membership of the user in an audience as well as a method of determining such an output.

### BACKGROUND TO THE DISCLOSURE

In life, many people share characteristics and interests. For example, some people like to go jogging, whereas some people prefer to watch TV; of course, some people like to both go jogging and to watch TV.

It can be useful to group people together for certain purposes; for example, if somebody is attempting to start a jogging club it would be useful for them to be able to identify other joggers. Such grouping is possible given a complete database of the personal information, characteristics, and activities of each person in a society. Given such a database, those people who regularly go jogging could be identified and contacted. However, in practice this information is not always easy to obtain—people who go jogging may well make no record of this activity. Furthermore, people are often reticent to share personal information—even people who do go jogging are unlikely to make this information publicly available.

Once a group of users has been determined, this group can be used, for example, for targeted advertising or for targeted notifications. In particular, the grouping may be used to determine audiences that may be interested in certain advertisements or notifications.

Therefore, there is a problem faced by parties attempting to sort people into groups.

### SUMMARY OF THE DISCLOSURE

According to at least one aspect of the present disclosure, there is described: an apparatus for determining an output for a user based on a membership of the user in an audience, the apparatus comprising: means for determining a threshold associated with membership of an audience (e.g. a processor and/or a communication interface); means for determining a score relating to a user in dependence on one or more activities of the user associated with the audience, wherein at least one activity is determined based on contextual information of the user (e.g. a processor and/or a communication interface); means for determining the membership of the user in the audience in dependence on whether the score exceeds the threshold (e.g. a processor); and means for providing an output for the user based on the membership of the user in the audience (e.g. a user interface and/or a communication interface).

Preferably, determining the membership of the user comprises determining whether the user should be placed into (and/or included in) the audience and/or determining whether the user should be removed from (and/or excluded from) the audience.

Preferably, the method comprises determining the contextual information. Preferably, the method comprises determining contextual information based on sensor data.

Preferably, the apparatus comprises a sensor for determining sensor data. In this way, the device is able to provide an output that is dependent on an environment of the user so that the output may have an effect that is suitable for, and tailored to, that environment.

Preferably, determining the membership of the user comprises determining a class of membership and/or a type of membership.

Preferably, the contextual information comprises information inferred from sensor data. Preferably, the apparatus comprises a means for receiving sensor data and/or contextual information from a further apparatus (e.g. a communication interface). Preferably, the contextual information comprises contextual information inferred using data from a plurality of apparatuses.

Preferably, the apparatus comprises means for determining a recency of one or more of the activities (e.g. a processor and/or a communication interface), and means for determining the score in dependence on the recency (e.g. a processor).

Preferably, the means for determining the score comprises means for scaling an existing score in dependence on a recency of the existing score.

Preferably, the means for determining the score comprises means for determining a component score for each activity. Preferably, each component score is dependent on one or more of: a magnitude of the action; a duration of the action; a recency of the action; a regularity and/or timing of the action; and a priority associated with the action.

Preferably, the apparatus comprises means for determining a scaling factor for each of the activities (e.g. a processor and/or a communication interface). Preferably, the scaling factor for each activity relates to the recency of said activity.

Preferably, the scaling factor is a function of the time that has passed since the determination of the score and/or activity. Preferably, the scaling factor is associated with an exponential decay.

Preferably, the apparatus comprises means for determining the score based on a distribution of the activities (e.g. a processor).

Preferably, the means for determining the threshold is arranged to determine the threshold based on a permission of the apparatus and/or user, the permission relating to the contextual information that the apparatus is able to access.

Preferably, the apparatus comprises means for determining a confidence, the confidence relating to the likelihood that the user should be a member of the audience (e.g. a processor).

Preferably, the means for determining a confidence comprises means for determining the confidence based on a difference between the score and the threshold, preferably a ratio of the score and the threshold.

Preferably, the means for determining the confidence is arranged to determine the confidence based on a permission of the apparatus and/or user, the permission relating to the contextual information that the apparatus is able to access.

Preferably, the apparatus comprises means for determining a strength relating to the degree to which a user identifies with the audience (e.g. a processor).

Preferably, the means for determining a strength comprises means for determining the confidence based on a difference between the score and the threshold, preferably a ratio of the score and the threshold.

Preferably, the means for providing an output comprises one or more of: means for outputting a confidence (e.g. a processor and/or a communication interface); means for outputting a liveness (e.g. a processor and/or a communication interface); means for outputting a notification in dependence on the membership (e.g. a processor and/or a communication interface); means for outputting a notification that the user is a member of the audience (e.g. a processor and/or a communication interface); means for providing a targeted notification (e.g. a processor and/or a communication interface); and means for providing an advertisement for the user based on the membership (e.g. a processor and/or a communication interface).

Preferably, the apparatus comprises means for determining an audience and/or the threshold in dependence on information received from a further apparatus (e.g. a processor and/or a communication interface). Preferably, the apparatus comprises means for determining the audience and/or the threshold based on information from a plurality of apparatuses (e.g. a processor and/or a communication interface). Preferably, the apparatus comprises means for receiving the audience and/or the threshold from a central server (e.g. a processor and/or a communication interface).

Preferably, the apparatus comprises means for determining at least one of the activities based on information received from a further apparatus (e.g. a processor and/or a communication interface).

Preferably the means for receiving information from the further apparatus comprises one or more of: means for determining whether the further apparatus has permission to share the contextual information (e.g. a processor); means for determining a receiving apparatus, the receiving apparatus being arranged to receive data (e.g. a processor); and means for determining a coordinating apparatus, the coordinating apparatus being arranged to transmit data (e.g. a processor). Preferably, the means for determining a receiving apparatus and/or a coordinating apparatus comprises means for determining the receiving apparatus and/or the coordinating apparatus based on the time at which the apparatus initiated a data sharing session.

Preferably, each activity is determined based on information located solely on the apparatus. By reducing the amount of data that is shared between devices, the disclosed apparatus provides increased data security for a user.

Preferably, the apparatus comprises a computer device.

Preferably, the apparatus comprises: means for receiving audience information form a further apparatus (e.g. a communication interface); and means for determining the threshold and/or the audience in dependence on the audience information (e.g. a processor).

Preferably, the apparatus comprises means for transmitting information relating to the membership to the further apparatus and/or a separate apparatus (e.g. a processor and/or a communication interface). Preferably, the means for transmitting information relating to the membership comprises means (e.g. a processor and/or a communication interface) for one or more of: transmitting an indication that the user is a member of the audience; transmitting a threshold for membership of the audience; and transmitting an indication of the score. Preferably, the means for transmitting information is arranged to transmit the information to a further apparatus that is arranged to determine new audiences based on the information.

Preferably, the apparatus comprises means for determining a liveness relating to an audience (e.g. a processor), preferably wherein the liveness relates to one or more of: whether, and/or how recently, the user has previously performed an activity associated with the membership of an audience; whether the user is currently performing an activity associated with the membership of an audience; and whether, and/or how soon, the user is expected to perform in the future an activity associated with the membership of an audience.

Preferably, the liveness relates to a relevance of a further activity of the user to the audience.

Preferably, the means for determining the membership comprises means for placing the user into the audience if the score exceeds a first threshold (e.g. a processor and/or a communication interface).

Preferably, the means for determining a membership comprises means for removing the user from the audience if the score is below a second threshold (e.g. a processor and/or a communication interface). Preferably, the first threshold and the second threshold are different thresholds.

Preferably, the means for determining the threshold for the audience is arranged to determine the threshold in dependence on the membership of the user of a further audience.

Preferably, the means for determining the threshold is arranged to determine a threshold for the user for the audience, the threshold being determined in dependence on a characteristic of the user. Preferably, the threshold for membership of the audience is different for different users.

Preferably, the means for determining the threshold is arranged to determine the threshold based on one or more of: a category of an application used by the user; a location of the user; a cultural and/or political identifier of the user; a seasonal characteristic; and/or a local event associated with the user.

Preferably, the means for determining a threshold is arranged to determine a threshold so as to maintain a certain number of users in the audience and/or a certain fraction of total users in the audience.

Preferably, the means for determining a threshold is arranged to determine a threshold in dependence on a recent change in the number of users in the audience.

Preferably, the means for determining the threshold is arranged to determine the threshold based on a characteristic of one or more existing members of the audience, preferably based on a characteristic of one or more existing members that exceed a threshold confidence, a threshold strength, and/or a threshold liveness.

Preferably, the means for determining the membership is arranged to determine the membership regularly. Preferably, determining the membership regularly comprises one or more of: determining the membership periodically, determining the membership based on an event. Preferably, the event is associated with the user entering and/or exiting a relevant context; determining the membership based on an input from a third party; and/or updating the membership.

Preferably, the means for determining a threshold comprises a communication interface for receiving information relating to the threshold from a further apparatus.

Preferably, the apparatus comprises means for determining an audience and/or the threshold based on one or more of: an operator-input rule; a supervised learning algorithm; and/or an unsupervised learning algorithm (e.g. a processor and/or a communication interface).

Preferably, the apparatus comprises means for determining the membership of the audience based on a previous membership status of the audience (e.g. a processor and/or a communication interface). Preferably, the apparatus comprises means for updating the membership status one or more of: regularly; infrequently; periodically; and based on an event (e.g. a processor and/or a communication interface).

Preferably, the apparatus comprises means for determining the context information using a sensor hierarchy comprising a plurality of nodes (e.g. a processor). Preferably, the sensor hierarchy comprises a plurality of nodes with each node comprising at least one hierarchical identifier. Preferably, at least one node comprises data indicative of a sensor.

Preferably, the apparatus comprises means for determining contextual information suitable for determining the activities of the user (e.g. a processor and/or a user interface). Preferably, the apparatus comprises means for determining contextual information in dependence on a user selection (e.g. a processor and/or a user interface). Preferably, the apparatus comprises means for determining contextual information in dependence on a subscription of the user to a node of the sensor hierarchy (e.g. a processor).

Preferably, the apparatus comprises means for determining an annotation for the user relating to an audience (e.g. a confidence, a liveness, a recency and/or a strength) (e.g. a processor). Preferably, the annotation comprises a range and/or error bounds. Preferably, the annotation is dependent on the type of information used to determine the annotation. Preferably, the annotation is dependent on a permission of the apparatus and/or user, wherein the permission relates to a type of communication that the apparatus is allowed to access.

According to another aspect of the present invention, there is disclosed a method of determining an output for a user based on a membership of the user in an audience, the method comprising: determining a threshold associated with membership of an audience; determining a score relating to a user in dependence on one or more of activities of the user associated with the audience, wherein at least one activity is determined based on contextual information of the user; determining the membership of the user of the audience in dependence on whether the score exceeds the threshold; and providing an output for the user based on the membership of the user.

It will be appreciated that the features described in relation to an apparatus are also disclosed in the context of a method (so that, for example, as well as the disclosure covering a means for determining contextual information, the disclosure covers the determining of contextual information).

Preferably, the method comprises determining a recency of one or more of the activities, and determining the score in dependence on the recency.

Preferably, determining the score comprises scaling an existing score in dependence on a recency of the existing score.

Preferably, determining the score comprises determining a component score for each activity. Preferably, each component score is dependent on one or more of: a magnitude of the action; a duration of the action; a recency of the action; a regularity and/or timing of the action; and a priority associated with the action.

Preferably, the method comprises determining a scaling factor for each of the activities. Preferably, the scaling factor for each activity relates to the recency of said activity.

Preferably, the scaling factor is a function of the time that has passed since the determination of the score and/or activity. Preferably, the scaling factor is associated with an exponential decay.

Preferably, the method comprises determining the score based on a distribution of the activities.

Preferably, determining the threshold comprises determining the threshold based on a permission of the apparatus and/or user, the permission relating to the contextual information that the apparatus is able to access.

Preferably, the method comprises determining a confidence, the confidence relating to the likelihood that the user should be a member of the audience.

Preferably, determining a confidence comprises determining the confidence based on a difference between the score and the threshold, preferably a ratio of the score and the threshold.

Preferably, determining the confidence comprises determining the confidence based on a permission of the apparatus and/or user, the permission relating to the contextual information that the apparatus is able to access.

Preferably, the processor is arranged to determine the membership of a user in a plurality of audiences.

Preferably, the processor is arranged to determine a set of audiences for a user based on the memberships of said user. Preferably, the set of audiences contains no more than 5 audiences, no more than 3 audiences, and/or not more than 2 audiences.

Preferably, the communication interface is arranged to transmit a set of audiences to a further device, wherein the set of audiences is associated with a percentage of the audiences of the user. Preferably, no more than 20% of the audiences of the user, no more than 10%, no more than 5%, and/or no more than 1%.

Preferably, the set of audiences and/or the size of the set of audiences is determined in dependence on one or more of: a request received by the apparatus; a correlation between one or more audiences associated with the user; and the apparatus and/or a user.

Preferably, the processor is arranged to determine a lookalike audience based on the audience and/or the set of audiences. Preferably, the lookalike audience is determined using one or more of: a regression model; a Bayesian network; and conditional probabilities associated with the audiences and/or the potential sets of audiences.

According to at least one aspect of the present disclosure, there is described an apparatus for determining an output based on a membership of the user in an audience, the apparatus comprising: a processor for: determining the membership of the user in a plurality of audiences; and determining a set of audiences, wherein the size of the set is smaller than the plurality of audiences; and a user interface and/or a communication interface for transmitting the set of audiences.

Preferably, transmitting the set of audiences comprises transmitting an indicator relating to a set of audiences (e.g. a binary indicator and/or an indicator that is associated with the set of audiences, wherein the receiving device is able to determine the set based on the indicator).

According to at least one aspect of the present disclosure, there is described: a system comprising: a first apparatus for determining an output for a user based on a membership of the user in an audience, the first apparatus comprising: means for determining a threshold associated with membership of an audience (e.g. a processor and/or a communication interface); means for determining a score relating to a user in dependence on one or more activities of the user associated with the audience (e.g. a processor), wherein at least one activity is determined based on contextual information of the user; means for determining the membership of the user in the audience in dependence on whether the score exceeds the threshold (e.g. a processor); and means for providing an output for the user based on the membership of the user in the audience (e.g. a processor and/or a communication interface); and a second apparatus comprising means for communicating with the first apparatus (e.g. a communication interface).

The first apparatus and the second apparatus may each be computer devices.

Preferably, the first apparatus is arranged to receive audience metadata from the second apparatus and/or to transmit membership information to the second apparatus (e.g. using the communication interface).

Preferably, the second apparatus is arranged to receive information (e.g. membership information) from a plurality of further apparatuses (e.g. using the communication interface).

Preferably, the second apparatus is arranged to determine an audience and/or a threshold for membership of an audience based on information received from a plurality of further apparatuses (e.g. using a processor).

Preferably, determining the audience and/or the threshold comprises using a machine learning algorithm, preferably a supervised machine learning algorithm and/or an unsupervised machine learning algorithm.

Preferably, the first apparatus is arranged to determine the score in response to a transmission from the second apparatus (e.g. in response to a transmission received at the communication interface of the first apparatus).

Preferably, the system comprises a further apparatus, wherein the first apparatus is arranged to determine one or more of the activities based on information received from the further apparatus.

Preferably, the further apparatus comprises one or more sensors, wherein the first apparatus and/or the further apparatus is arranged to infer contextual information based on measurements from the one or more sensors.

Preferably, the second apparatus comprises and/or is the further apparatus.

Preferably, two or more of the first apparatus, the second apparatus, and the further apparatus are implemented on a single device. For example, each apparatus may comprise an application on a single computer device.

Preferably, the first apparatus is arranged to determine the output in dependence on a transmission from the second apparatus. Preferably, the first apparatus is arranged to determine a targeted advertisement in dependence on the membership information and/or an advertisement received from the second apparatus.

Any feature described as being carried out by an apparatus, an application, and a device may be carried out by any of an apparatus, an application, or a device. Where multiple apparatuses are described, each apparatus may be located on a single device.

Any feature in one aspect of the disclosure may be applied to other aspects of the invention, in any appropriate combination. In particular, method aspects may be applied to apparatus aspects, and vice versa.

Furthermore, features implemented in hardware may be implemented in software, and vice versa. Any reference to software and hardware features herein should be construed accordingly.

Any apparatus feature as described herein may also be provided as a method feature, and vice versa. As used herein, means plus function features may be expressed alternatively in terms of their corresponding structure, such as a suitably programmed processor and associated memory.

It should also be appreciated that particular combinations of the various features described and defined in any aspects of the disclosure can be implemented and/or supplied and/or used independently.

The disclosure extends to methods and/or apparatus substantially as herein described with reference to the accompanying drawings.

The disclosure will now be described, by way of example, with reference to the accompanying drawings.

### DESCRIPTION OF THE DRAWINGS

FIGS. 1a and 1b show a computer device and a system on which the systems and methods disclosed herein may be implemented.

FIG. 2 shows a method of determining membership of an audience for a user.

FIG. 3 shows another method of determining a membership of an audience for a user.

FIGS. 4a and 4b show a method of determining a membership of a first audience for a user based on membership of a second audience.

FIG. 5 illustrates the determination of memberships based on contextual information.

FIG. 6 shows a system for calculating an audience of a user.

FIGS. 7a to 7c show various systems for determining and transmitting audience memberships.

FIGS. 8a and 8b illustrate a method of determining memberships based on the recency of activities.

FIG. 9 shows a method of determining a set of audiences.

### DESCRIPTION OF THE PREFERRED EMBODIMENTS

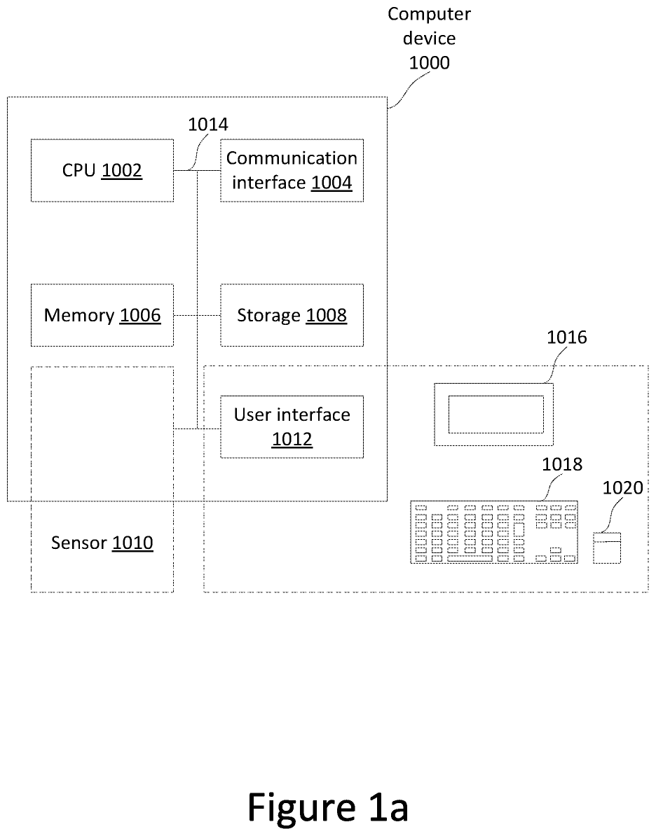

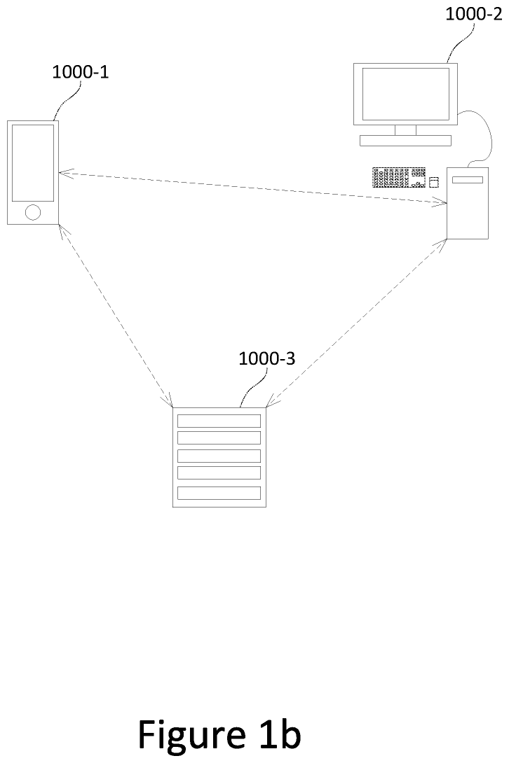

Referring to FIG. 1a, the methods and systems described herein are typically implemented using one or more computer devices 1000. Each computer device comprises a processor in the form of a CPU 1002, a communication interface 1004, a memory 1006, storage 1008, a sensor 1010 and a user interface 1012 coupled to one another by a bus 1014. The user interface typically comprises a display 1016 and an input/output device, which in this embodiment is a keyboard 1018 and a mouse 1020.

The CPU 1002 is a computer processor, e.g. a microprocessor. It is arranged to execute instructions in the form of computer executable code, including instructions stored in the memory 1006 and the storage 1008. The instructions executed by the CPU include instructions for coordinating operation of the other components of the computer device 1000, such as instructions for controlling the communication interface 1004 as well as other features of a computer device such as a user interface 1012. In various embodiments, the CPU comprises a graphical processing unit (GPA), a field programmable gate array (FPGA), a coarse grain reconfigurable array (CGRA), or an application specific integrated circuit (ASIC). It will be appreciated that a variety of other circuits, e.g. logic circuits, and electrical components may be used to perform operations and/or implement methods using software or hardware.

The memory 1006 is implemented as one or more memory units providing Random Access Memory (RAM) for the computer device 1000. In the illustrated embodiment, the memory is a volatile memory, for example in the form of an on-chip RAM integrated with the CPU 1002 using System-on-Chip (SoC) architecture. However, in other embodiments, the memory is separate from the CPU. The memory is arranged to store the instructions processed by the CPU, in the form of computer executable code. Typically, only selected elements of the computer executable code are stored by the memory at any one time, which selected elements define the instructions essential to the operations of the computer device being carried out at the particular time. In other words, the computer executable code is stored transiently in the memory whilst some particular process is handled by the CPU.

The storage 1008 is provided integral to and/or removable from the computer device 1000, in the form of a non-volatile memory. The storage is in most embodiments embedded on the same chip as the CPU 1002 and the memory 1006, using SoC architecture, e.g. by being implemented as a Multiple-Time Programmable (MTP) array. However, in other embodiments, the storage is an embedded or external flash memory, or such like. The storage stores computer executable code defining the instructions processed by the CPU. The storage stores the computer executable code permanently or semi-permanently, e.g. until overwritten. That is, the computer executable code is stored in the storage non-transiently. Typically, the computer executable code stored by the storage relates to instructions fundamental to the operation of the CPU.

The communication interface 1004 is configured to support one or more of: short-range wireless communication, e.g. Bluetooth® and Wi-Fi communication, long-range wireless communication, e.g. cellular communication, and an Ethernet network adaptor. In particular, the communications interface is configured to establish communication connections with other computing devices.

The storage 1008 provides mass storage for the computer device 1000. In different implementations, the storage is an integral storage device in the form of a hard disk device, a flash memory or some other similar solid state memory device, or an array of such devices.

The sensor 1010 is configured to obtain information relating to the computer device 1000, a user of the device, and/or the environment. In different implementations, the sensor is a GPS sensor, a temperature sensor, a proximity sensor, a heart rate sensor, an accelerometer, an infrared sensor, an impact sensor, a pressure sensor (e.g. a barometer), and/or a gyroscope. It will be appreciated that a number of other sensors as are known in the art may also be used. Typically, the computer device contains a plurality of sensors, where the sensors are adapted to provide sensory data to an application on the computer device.

In some embodiments, there is provided removable storage, which provides auxiliary storage for the computer device 1000. In different implementations, the removable storage is a storage medium for a removable storage device, such as an optical disk, for example a Digital Versatile Disk (DVD), a portable flash drive or some other similar portable solid state memory device, or an array of such devices. In other embodiments, the removable storage is remote from the computer device, and comprises a network storage device or a cloud-based storage device.

The user interface 1012 typically comprises one or more actors that are adapted to perform operations that have an effect external to the computer device 2000. In some embodiments, this is the display 2016, which is useable to display information and/or video. In some embodiments, the user interface comprises a speaker, a locking mechanism, an actuator and/or a robot. The user interface is in various embodiments, adapted to: play music and/or audio, lock and/or unlock a door or other access means; grasp; move; interact with an object; and interact with a user.

A computer program product is provided that includes instructions for carrying out aspects of the method(s) described below. The computer program product is stored, at different stages, in any one of the memory 1006, the storage 1008 and the removable storage. The storage of the computer program product is non-transitory, except when instructions included in the computer program product are being executed by the CPU 1002, in which case the instructions are sometimes stored temporarily in the CPU or memory. It should also be noted that the removable storage is removable from the computer device 1000, so that the computer program product may be held separately from the computer device from time to time.

Typically, the computer device 1000 is a smartphone. Equally, the computer device may be a personal computer (PC), a smartwatch, a smart appliance (e.g. a smart TV), or any other device with a processing capability. Furthermore, the described systems and methods may be implemented using a plurality of computer devices, where different steps of the methods are performed on different devices. In such cases, each device may be designed for an intended purpose. For example, data may be collected using a smartphone with a plurality of sensors 1010 before being transferred (via the communication interface 1004) to a server with a powerful CPU 1002 that can rapidly process this data; the results of the processing may then be transferred to a device with a large display 1016, where these results are then output to a user.

Referring to FIG. 1b, there is described a system comprising a plurality of computer devices 1000-1, 1000-2, 1000-3. Certain aspects of the methods disclosed herein may be disclosed on each of the devices.

The devices may comprise: one or more personal devices of a first user (e.g. a smartphone 1000-1 and a personal computer 1000-2); one or more devices of other users; and a central server 1000-3.

The central server 1000-3 is typically arranged to receive information from the devices of a plurality of users. This information may be used to determine audiences (as described further below). Any personal information may be anonymised before being sent to the central server so that users do not need to share any personal information with the central server.

Furthermore, the central server 1000-3 may be arranged to receive and/or store membership information relating to the users. In particular, the central server may keep a record of the users that belong to each audience. A third party (e.g. an advertiser) may then use this membership information recorded on the central server in order to provide targeted notifications for each of the users.

At least one device of the user typically comprises a sensor from which sensor data relating to the user may be obtained. Contextual information relating to the user can then be inferred from this sensor data. The sensor data and/or the contextual information can then be used to determine an activity of the user (as described further below). Typically, sensor data and/or information from a plurality of devices is combined in order to determine the activities of the user, this may involve information being transmitted between a plurality of devices of a user. Typically, such information is transmitted only between the devices of a user and not, for example, to the central server 1000-3. This avoids the transmission of personal information away from the personal devices of a user.

Each of the devices may be capable of obtaining different types of data and/or information. For example, a smartphone of the user may be able to determine the user's location, while a smart TV of the user may be able to determine the user's viewing preferences. By combining information from a plurality of devices, an accurate determination of the activities of the user is possible.

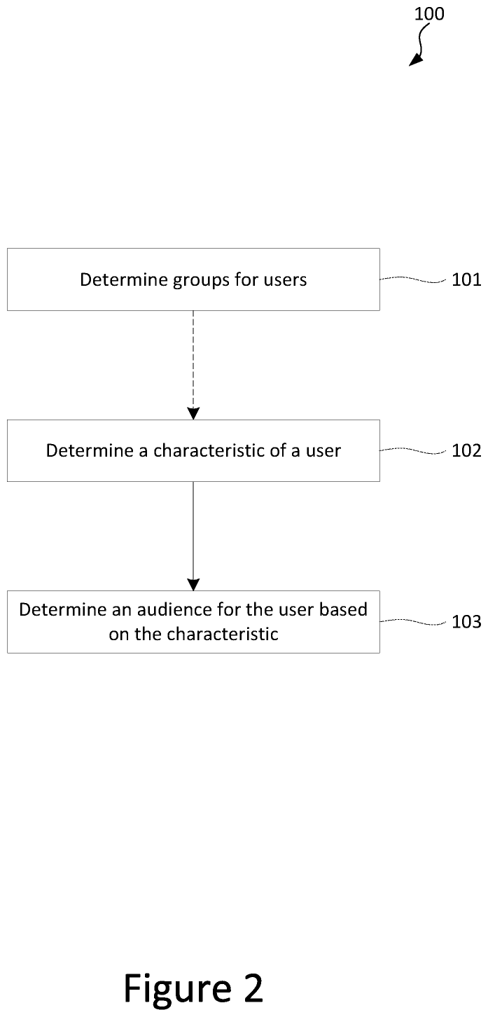

Referring to FIG. 2, there is disclosed a method 100 of determining an audience for a user. This method may be implemented using the computer device 1000 (e.g. the computer device of a user and/or the central server 1000-3 comprising information relating to a plurality of users).

In a first step 101, the computer device 1000 determines one or more audiences for users.

These audiences may be determined based on rules; for example, there may be audiences for users that have certain applications downloaded or certain behavioural patterns.

Equally, these audiences may be determined using artificial intelligence and/or machine learning, where audiences are determined based on similarities between users. The use of machine learning enables large quantities of data to be processed and can enable non-obvious audiences to be determined. This method of determining audiences may comprise supervised or unsupervised learning.

In a second step 102, the computer device 1000 determines a characteristic of a user.

In a third step 103, the computer device determines membership of the user in an audience based on the characteristic.

For example, the user may be placed into an audience containing users with similar behavioural patterns.

The second step 102 and third step 103 may take place substantially later than the first step 101. Furthermore, the first step typically takes place on the central server 1000-3, where the audiences can then be transmitted to individual user devices. The second step and third step typically place on the individual user devices, so that personal data need not be transmitted from these devices in order to place a user into an audience.

The information required to determine audiences and to place users into these audiences may be taken from a plurality of user devices; for example, this information may be obtained from the phone, personal computer (PC), and a smartwatch of a user. This enables the collection of an array of data.

Once a user has been placed into an audience, they can be associated with the other users of that audience. For example, advertisements may be sent to members of an audience, where a sporting company may wish to advertise to an audience of users who exercise regularly.

Therefore, the audiences may be used to group users sort users with similar characteristics, which audiences are likely to be receptive to particular transmissions. An audience can be considered a grouping of one or more people sharing a same or similar characteristic (and “audiences” and “groups” are used interchangeably in this description).

Equally, the audiences may be used, for example, to determine groups of users of a certain age or groups with traits that place them at risk; the audiences may then be used to issue alarms or warnings to audiences (e.g. an audience of users that likes outdoor activities may be sent warnings during periods of low air quality).

A potential issue with the method 100 described in FIG. 2 is that it can require the processing of personal information, such as the locations, names, or characteristics of users. It is desirable to avoid the dissemination of this information.

In various embodiments, the data used to determine audiences and/or to determine memberships of users comprises one or more of:
Purchase history (e.g. for e-commerce platforms).
Browsing history (e.g. for search engines or web browsers).
Music preferences (e.g. for audio/video platforms).
News stories and articles read (e.g. for publishing platforms).
Voluntarily provided information (e.g. for social media platforms).
User engagement. This may be determined using gaze detection and/or mouse movements and may be used to indicate an amount of time that a user has spent focusing on an object or an intensity of focus.
Geolocation.

According to the present disclosure, there is described a method of determining audiences of a user in which personal information does not leave a user device.

In particular, information regarding possible audiences may be transmitted to a user device, with the user device then being placed into appropriate audiences based on information on the device. This determination of audiences may remain solely on the user device, so that, for example, a user's phone may be placed into an audience where this grouping is not known by other devices. Equally, the memberships may be shared with other devices. In either embodiment, the information used to determine the memberships (which may be personal information) need not leave the device. Therefore, an advertiser may, for example, be able to identify that a user or a device is a sports enthusiast without knowing exactly why this member is deemed to be a sports enthusiast. This avoids the need to share personal information across devices.

In order to determine appropriate audiences, contextual information relating to a user may be considered. ‘Contextual information’ preferably connotes information that relates to the context of a user and/or information that is inferred. Typically, the information is inferred from sensor data and/or from information received from other devices. Examples of inferring information include: inferring a stress level from heart rate data; inferring a location from a time and a user's historic behaviour (e.g. from a street sign or a business name); and inferring a time of day (e.g. dawn/dusk) from a time and an ambient light level. Furthermore ‘contextual information’ preferably includes information about events that are happening, that have happened, or that are expected to happen. As an example, a user's context may be “just left a shop”, “entering a shop”, or “walking, probably to a shop”.

In some embodiments, contextual information is inferred from a user's behaviour in relation to an application. In particular, a type of application used by a user (e.g. a puzzle game or music player) may be determined as well as information relating to in-app purchases, browsing behaviour, user engagement etc.

Contextual information determined from the sensors of a computer device is typically combined with contextual information determined from the application usage of a user in order to determine audience memberships.

Contextual information may comprise sensor data, metadata about an app or website, usage statistics of a user using the app or website, or a combination of one or more of these types of data.

Audiences are typically selected based on similarities between users.

In some embodiments, audiences are based on rules input by an operator. For example, a user that has been running for more than 30 minutes on three separate occasions over the previous week could be reasonably assumed to be a “frequent jogger” and/or a “fitness enthusiast” (and this user may be placed in a corresponding audience). If it transpired that the running was between 7 am and 9 am, this user could also be placed in a “morning jogger” audience. These audiences may be based on the input rules; for example, the operator may state that everyone who runs before 9 am more than once a week is a “morning jogger”.

Such rules can be written according to reasonable expectations, like the above, or can be determined by quantitative analysis of users; for example, an operator may perform a survey to determine the average bedtime of users in order to make a threshold for a “night owls” audience.

Rule-based systems may also be written in multiple layers, using existing memberships to refine the thresholds for other audiences. For example, a user in a “night-shift workers” audience should not be assigned to the “all-night party goers” audience despite the fact that both audiences relate to the behaviour of staying awake all night. The presence of one precludes the other for at least part of the week. Therefore, the rules may be interdependent, where some audiences may be compatible (where a user can be in both audiences), some audiences may be contradictory (where a user cannot be in both audiences) and some audiences may be subsets (where a user cannot be in a second audience unless that user is also in a first audience).

In some embodiments, data from users (e.g. contextual information and/or characterising information) is represented as a space. For example, each user may be represented as a space in N dimensions relating to a proportion of the user's total time spent in each of the N different contexts (e.g. exercise level, stress level, whether indoors or outdoors etc.). The distance of points in this space can be used to represent the similarity of user behaviours as defined by this statistical measure, with lower distance relating to greater similarity.

Audiences can then be determined based on a similarity in this space, where this may reveal surprising audiences. There are well known methods of unsupervised clustering in which an accompanying heuristic is needed to help direct the clustering (e.g. in unsupervised k-means clustering the total number of clusters, k, is determined using a heuristic). Rule based clustering requires hand-crafting the desired audiences, whereas unsupervised clustering only requires the definition of this heuristic, at which point it will generate new audiences automatically.

An N-dimensional space is typically used alongside an unsupervised learning algorithm. An operator may then review the groupings determined using the learning algorithm to determine uses for these audiences.

It will be appreciated that rule-based grouping based on operator inputs may be combined with automated grouping based on artificial intelligence or machine learning.

The grouping of users (determining an audience of users and/or determining a membership for one or more users) can occur either on a single user device, or on a computer device that collects information from a plurality of users and/or devices, such as a central server. Performing the grouping on a single device has privacy benefits, since no user data needs to leave the device. However, without collating data from a plurality of users and/or devices, it can be difficult to accurately place users in audiences and difficult to use supervised or unsupervised learning approaches.

By transferring the data to a central device, such as an internet-connected server, data from multiple users can be correlated for unsupervised learning at the cost of reduced privacy.

Regardless of where the grouping occurs, the resulting audience memberships may be transferred wherever they are to be used, which may be the device on which the grouping occurs, or may be a separate device.

In embodiments where the grouping occurs on a single device (so that personal information does not need to be transmitted away from that device), an intermediate fingerprint can be used in order to transmit information that is either linearly or nonlinearly separable with an unsupervised machine learning algorithm, but which does not compromise the user's personal information or memberships.

A fingerprint of this sort represents a latent representation of information that, on its own, cannot identify personal information of the user to which it pertains, but can be used to successfully cluster users with similar characteristics; albeit that the knowledge the cluster represents is unknowable.

An example fingerprinting technique is provided for context as follows:

Consider a ‘pseudo-audience’ that represents a combination of having visited a fishing shop, ridden a bicycle, and worked from home within a 72 hour period. This pseudo-audience is sent from a central server to multiple computer devices. The devices now each measure a ‘distance’ from this pseudo-audience based on how closely the behaviour of the user of that device matches this profile. This distance metric may be multidimensional, and may be constructed such that it does not reveal any specific component of the pseudo-audience that may be objectively true for the user, such as the fact they have been to a fishing shop.

This is repeated for multiple pseudo-audiences. The server then receives the distance metrics as a fingerprint of the various users, where no particular aspect of any user's life is deterministically identifiable.

An unsupervised clustering algorithm can then be used to create new audiences which have no communicable meaning, but nonetheless represent common behaviours between multiple users.

These new audiences may be tested for efficacy for the desired application. For example, in advertising, comparing the click-through-rate (the number of times an advert is clicked or otherwise interacted with) for users with and without a membership to a particular audience may be used to identify if there is a significant difference (and thereby to identify whether the audience is useful). Any difference, regardless if a positive or negative effect, can be used to optimise a targeted advertising campaign.

According to the present disclosure, users, devices, and/or audiences may be annotated with additional information. In particular, annotations may relate to:
A confidence: the confidence is associated with a likelihood of a user and/or a device being a member of an audience. This may be represented as a percentage, where this percentage may be related to the information of a user. The confidence of a user is typically dependent on the activities undertaken by that user and/or the recency of those activities (as described further below). In a practical example, a user that has been running for at least twenty minutes at 8 am five days in a row may have an 80% probability of being a “morning jogger”. A user that has been running for only ten minutes at 8 am three times in the past fortnight may have a 30% probability of being a “morning jogger”.
The confidence may depend on a fraction of a membership threshold that is met by a user. For example, if there is a threshold of four jogs (in a given time period) required to be a member of a “jogging” audience, then a user that completes two jogs may have a 50% confidence rating associated with membership of this audience. Any user that completes four or more jogs may have a 100% confidence rating. Equally, any user that has not completed four jogs may have a 0% confidence rating, where a user that completes four jogs may have a less than 100% confidence rating and a user may need to complete, say, at least ten jogs to have a 100% confidence rating.
It will be appreciated that the confidence rating for a user may depend on a plurality of parameters, e.g. a number of activities performed, a duration of those activities, membership of the user in other audiences, etc.
In some embodiments, users are associated with a discrete measure of confidence, for example, users may be associated with one or more of a plurality of distinct confidence buckets. This may comprise users being in one of a ‘high’, ‘medium’, or ‘low’ confidence bucket.
A strength: the strength is associated with the degree to which a user and/or a device identifies with an audience (e.g. the frequency with which the user performs activities associated with this audience). For example, a first user that jogs five times a week and a second user that jogs ten times a week may both have a high confidence of being a jogger, but the first user may be given a higher strength rating, since this user jogs more often.
In various embodiments, the strength rating is associated with one or more of: a number of activities, and a duration and/or magnitude of the activities.
A recency: the recency is associated with the time that has elapsed since a user and/or a device has performed an activity associated with an audience. For example, the recency may relate to the last update and/or alteration to the membership of a user. Similarly, there may be an indication given of when a user was placed in an audience. Furthermore, according to the present disclosure, the audiences of a user may be updated periodically. Therefore, it may be checked regularly whether a user should still belong to an audience—and the computer device 1000 may be arranged to perform this check. This may comprise updating the audiences of a user periodically (e.g. once every day, once every week, and/or once every month) or updating the audiences of a user based on events (e.g. if a substantial change in location is detected). Therefore, the placement of a user in the “morning jogger” audience may be regularly reviewed. In a practical example, if a user has not been active in the mornings for a certain period of time (e.g. for a month), the user may be removed from this audience. The recency and confidence are typically related, so that a user who is likely to be a “morning jogger” may remain in this audience despite a recent lack of activity (albeit with the confidence typically reducing over time), whereas a user that is less likely to be a “morning jogger” may be removed from this audience more quickly.
The recency may be associated with a score of the user and/or an activity of the user. For example, a “jogging” activity may have a score of 1 if performed in the last day, a score of 0.5 if performed in the last week and a score of 0 otherwise. Typically, the recency is implemented as a scaling factor, where the score of a user and/or a score of one or more activities of the user is scaled according to a recency scaling factor.
Membership of an audience may depend on a certain number of activities having been performed in a certain timeframe (e.g. a user having gone jogging three times in the last week); this can be considered to be implementation of a recency scaling factor, where activities of more than a week ago may have an applied recency scaling factor of zero.
A liveness: the liveness is associated with the difference between the present time and a time at which user and/or a device performs or performed an activity associated with an audience. This difference may be negative, e.g. where the user has performed the activity in the past, or positive, e.g. where the user is expected to perform the activity in the future. Similarly, the liveness may be a qualitative measure (e.g. the user has performed a relevant activity “recently”, the user is currently performing a relevant activity, or the user is expected to perform a relevant activity “soon”). A user and/or a device may be given a liveness rating where the liveness indicates the current behaviour of the user/device as it relates to an audience. For example, a “morning jogger” that is currently jogging may have a liveness rating of “0”. A “morning jogger” that has been jogging five minutes ago may have a liveness rating of “−5”. A “morning jogger” that normally runs at 7:45 may be given a liveness rating of “15” when the time is 7:30. Therefore, a party that is interested in morning joggers (e.g. a company selling running shoes) is able to identify when a user has just finished a run or when a user is about to start a run (and might be interested in advertisements for running shoes).
Liveness typically includes a measure of a time since a certain behaviour was observed or a time before a predicted behaviour is expected (e.g. a time in seconds, minutes, or hours).
Furthermore, the liveness may relate to a type of activity being performed by a user. For example, a “morning jogger” that is currently jogging may have a liveness factor of 1, a “morning jogger” that is currently stationary may have a liveness factor of 0, and a “morning jogger” that is currently playing another sport may have a liveness factor of 0.5. In some embodiments, the liveness indication comprises a plurality of elements, so a first element may relate to the time since a certain behaviour has been observes and a second element may relate to the relevance of this behaviour to the audience.
The relevance of an activity to an audience may be determined, for example, based on operator-input rules, and/or supervised and/or unsupervised learning algorithms. As examples, playing sports is likely to be relevant to a “morning jogger” audience (since both jogging and playing sports use sporting equipment. However, eating dinner might have a negative relevance to a “morning jogger” audience (since users that are currently eating might not wish to think about exercise).

These annotations may be output to a user and/or a third party; for example, the user may be shown an output that states: {audience: “joggers”, confidence: “high”, liveness: “−5 minutes”}.

The liveness rating may be used to trigger an output and/or an alarm. For example, the computer device may transmit a notification to another computer device based on the liveness score exceeding (or falling below) a threshold. This may lead to a notification being sent: just before a user begins an activity; when a user is performing an activity; just after a user has finished an activity; and/or when a user has not performed an activity for some time. This threshold may also be dependent on the confidence and/or recency ratings of the user. Each threshold may have a different use, for example a user in a “morning jogging” audience that has a liveness rating indicating they are likely to go jogging soon may be interested in receiving alerts regarding upcoming poor weather. Similarly, a user in a “jogging” audience that has not been jogging for some time (but that has a high confidence relating to membership of this audience due to a long history of jogging) may be determined to be potentially injured, where this determination could be used to suggest treatments to common jogging injuries,

The above annotations are typically dependent on each other and/or considered in combination. This enables a viewer of the audiences to: determine audiences to which a user belongs; determine how likely it is that a user does indeed belong to an audience; determine whether this assessment is up-to-date; and determine whether the user is likely to be thinking about or performing an activity related to an audience.

In some embodiments, the threshold used to determine whether a user is a member of an audience is dynamic; for example, being a “morning jogger” may require jogging three times a week during summer, but only twice a week during winter. In particular, the threshold may be dependent on a circumstance of the user, such as a season and/or a location.

The determination of whether a user is a member of an audience may depend on one or more of:
A category of an application used by a user: some apps are more or less likely to be associated with particular contexts: e.g. music apps are more likely to be used while running than a gaming app. They are also more or less likely to be associated with certain demographics.
A geographic location: different places in the world have varied access to things. For example, beach goers (users who like to go the beach) are more likely to be found in coastal cities. Furthermore, beach goers in inland cities are likely to visit the beach less than beach goers in coastal cities. Therefore, a membership threshold for a user based on the coast to be placed in a “beach goer” audience may be greater than the membership threshold for a user based further inland.
Cultural or political differences: users behave differently depending on their cultural background and on the laws and regulations of their country. For example, whereas dinner in the UK is usually eaten around 6-8 pm, in Spain it is more usually 9-11 pm. Therefore, membership in a “night owl” audience may depend on the background and/or location of a user.
Seasonal fluctuations: people behave differently depending on the weather. Typically, people are more likely to engage in outdoor activities such as running during warm and dry conditions.
Local events: national holidays or significant local events are likely to affect user behaviour; for example, people are more likely to be awake late at night on New Year's Eve; therefore, certain days and/or occasions may be discounted or weighted when considering memberships for a user.
Force majeure: significant events will change people's behaviours—e.g. even regular pubgoers have been unable from visiting pubs during the coronavirus pandemic.

There are several ways that the thresholds can be re-calculated. One way that can be easily automated is to assume that the distribution of the audience is uniform across these categories. For example, the data may show that 10% of users are runners. This number could fall to 5% during the winter since, because it is cold, runners may decide to run less often or to stop running. The thresholds for membership of the “runners” audience may be lowered such that the proportion of runners remains at 10%. In this case, the uniformity assumption is well-justified: those users have not stopped being runners, rather they run with less intensity in the winter.

Therefore, the threshold for membership of an audience may be determined such that a certain amount of users and/or proportion of users are placed in the audience.

In practice, this can be achieved through use of a dynamic threshold for membership of an audience, where the threshold is dependent on a number of users in the audience and/or a fraction of total users that are in the audience. A computer device may be arranged to determine a threshold in dependence on one or more of:
The number of users in the audience and/or a change in the number of users in the audience. For example, if the membership of an audience begins to rapidly reduce, this may be an indication that the membership threshold should be lowered.
A characteristic of one or more users in the audience. For example, a certain number of users may be selected as representative members. These may comprise users with a certain confidence, recency, and/or liveness rating. This selection may also involve a random or pseudorandom selection of users. A threshold for membership of the audience may be determined based on the characteristics of these representative users. In a practical example, if a user is a representative member of the “jogging” audience and their frequency of jogging decreases from ten times a week to five times a week it may be inferred that an external factor is discouraging users from jogging and so the threshold for membership of the “jogging” audience may be lowered. Typically, the threshold is dependent on a characteristic of a plurality of users in the audience (e.g. at least 10, at least 50, at least 100, and/or at least 1000); this prevents personal factors, such as injury of a user, from having an undue effect on the threshold.
A local event, e.g. a local holiday.
A climate event, e.g. the start of winter.
An event, e.g. the presence of a popular gaming convention may lead to a short term increase in interest in computer games in a city.

In general, the threshold for membership of an audience may be altered in dependence on a change in the population of that audience and/or a change in the behaviour of the population of that audience. In particular, the threshold may be altered to maintain a certain population (e.g. a number of users), a certain population range, and/or a certain proportion of total users.

In some embodiments, the threshold for membership of an audience is dependent on a characteristic of a group of users and/or a difference in a characteristic between two groups of users. For example, there are no federally guaranteed paid holidays for American workers, but in Europe most workers get a minimum of 3-4 weeks off a year. It might therefore be appropriate to alter a threshold for the “workaholics” audience to account for this difference. Since in this case the root cause of the difference is known, it is possible to estimate how much the thresholds should change in order that they measure the same behaviour. e.g. if Americans work 10% more hours than Europeans on average, increasing the work hours needed for Americans to be placed in the “workaholics” audience by 10% is justified.

In some embodiments, the threshold for a user to belong to an audience depends on membership of another audience. Continuing with the example above, a first user may be placed in an “Europeans” audience (e.g. based on GPS data) and a second user may be placed in an “Americans” audience. The threshold for the first user to be placed in a “workaholics” audience may be working 60 hours a week, while the threshold for the second user to be placed in the “workaholics” audience may be working 66 hours a week. This threshold may also depend on another grouping of the users; for example if the first user is also in a “commercial lawyer” audience, the threshold for this user to be placed in the “workaholics” audience may be increased to 72 hours a week, where if the second user is also in an audience that is “part-time workers”, the threshold for this user to be placed in the “workaholics” audience may be halved to 33 hours a week (or this user may be precluded entirely from being placed in the “workaholics” audience).

In practice, this can be implemented via the use of modifiers, where a modifier relating to a threshold for a user to be placed in a first audience is dependent on the membership of that user in one or more other audiences. So the default threshold for membership in the “workaholics” audience may be working 60 hours a week, where membership in the “Americans” audience results in a 10% modifier being applied to this threshold. A modifier may result in a scaling of a threshold or an addition to a threshold (e.g. membership in the “Americans” audience may result in a 6 hour addition to the threshold). More generally, the modifier may modify the threshold in any way, so that this modifier could be a complex function that depends on a variety of audience memberships of the user in question.

The determination of membership of an audience for a user typically depend on one or more of:
A magnitude of an action (e.g. for how long a user runs).
A regularity of an action (e.g. how often a user runs and/or the average gap between a user's runs).
A priority (e.g. if a user needs to choose between running and going to the pub which action does this user tend to choose).

Typically, the effect of actions of the user on audience membership decays with time. For example, a user that goes jogging five times in a week may be placed in the “joggers” audience, but if that user then does not go jogging for some time, the user may be removed from the “joggers” audience. In practice, this may be implemented by applying a score to each action where this score is modified by a time scaling factor.

For example, a user's “jogging” score may be calculated by:

$$score = {\sum }_{i = 1}^{n} {x}_{i} * σ ( t )$$

Where:
xᵢ is a score relating to an activity x (e.g. the score may be equal to the number of minutes run divided by five, so that a five-minute run receives a score of 1 and a ten-minute run receives a score of 2);
σ(t) is a scaling factor depending on the recency of the activity xᵢ; and
n is the number of relevant activities.

Continuing with this example, and considering:
a user who performs:
   A five-minute jog on 1 January.
   A ten-minute jog on 2 January.
   A ten-minute jog on 5 January.
   A twenty-minute jog on 25 January.
A decay function that is equal to

$$σ ( t ) = min ( 1 - \frac{{t}_{n o w - {t}_{{x}_{i}}}}{30} , 0 ) ,$$

where
tₓ_{ᵢ}; is the time at which the activity xᵢ, occurred in days;
t_{now} is the present day;

The score of the user is:

$$On 2 January : {score}_{2 Jan} = 1 * \frac{29}{30} + 2 = \frac{59}{30}$$

$$On 5 January : {score}_{5 Jan} = 1 * \frac{26}{30} + 2 * \frac{27}{30} + 2 = \frac{140}{30}$$

$$On 23 January : {score}_{23 Jan} = 1 * \frac{9}{30} + 2 * \frac{10}{30} + 2 * \frac{13}{30} = \frac{55}{30}$$

$$On 25 January : {score}_{25 Jan} = 1 * \frac{6}{30} + 2 * \frac{8}{30} + 2 * \frac{10}{30} + 4 = \frac{162}{30}$$

$$On 10 February : {score}_{24 Feb} = 1 * 0 + 2 * 0 + 2 * 0 + 4 * \frac{14}{30} = \frac{56}{30}$$

If the threshold for membership of the “jogging” audience is a score of 2, then the user will join the “jogging” audience on 5 January, leave the audience on 23 January, join the audience again on 25 January, and leave the audience again on 10 February.

The confidence score relating to the membership of this user may vary similarly, where the confidence score is at its greatest on 25 January.

It will be appreciated that this is only a very simple example. In particular, the calculation of scores, the decay function, and the membership threshold may all be determined using more complex calculations.

In various embodiments, the score of a user is dependent on one or more of:
a timing of one or more activities;
a duration and/or magnitude of one or more activities;
a distribution of activities (e.g. a mean duration, a frequency of activities, and/or a variance and/or kurtosis of activities).
The distribution of activities may comprise a distribution of timings (e.g. there may be determined a mean number of activities performed in a given timescale and a variance based on the time between each activity); equally, the distribution may comprise a distribution of magnitudes (e.g. there may be determined a mean activity duration and a variance based on the difference between the duration of each activity and this mean duration).
The use of a distribution may be combined with a recency factor, where each activity score is scaled by a recency factor before the determination of the distribution.
Where a distribution is used, the threshold required for membership of an audience may, for example, relate to a threshold mean value or a threshold variance value.

Typically, the decay function is arranged so that the contribution of an activity to the membership of a user of an audience (e.g. to a user's score) decays exponentially and/or in a stepped manner.

In some embodiments, the threshold for a user to be placed in an audience is greater than the threshold for a user to leave that audience. With the example above, the joining threshold for the “jogging” audience may be a score of 2, while the leaving threshold may be a score of 1. With this example, the user would remain in the “jogging” audience for the entirety of the 2 January to 10 February period considered in the example above.

The threshold may also depend on one or more of: the user having performed a threshold number of actions; the user having performed an action of a certain magnitude (e.g. a certain length of run); and/or a certain period having passed since the first action performed by a user.

The ‘actions’ typically relate to the determination of a user context, so with the example above, the determination of each action may comprise the determination of the user being in a “jogging” context. This determination may comprise the inference of a “jogging” context based on a combination of GPS data and accelerometer data.

The determination of a current score may be based on a previous score and a recent activity. For example:

$${score}_{2} = {score}_{1} * * σ ( t ) + {x}_{i}$$

Continuing with the example above, the score of the user on 23 January is known to be

$${score}_{23 Jan} = \frac{55}{60} .$$

When determining the score on 25 January, instead of considering each of the past activities, this score may be combined with a decay function and any recent activity data. For example, the score may decay by 10% each day, so that the score on the 25 January is calculated as

$${score}_{25 Jan} = {score}_{25 Jan} * {( 0.9 )}^{25 - 23} + 4 = \frac{55}{60} * {( \text{.9} )}^{2} + 4 = \frac{4455}{6000} + 4 = \frac{28455}{6000} .$$

Such a method using a combination of a previous score and a decay function avoids the need to perform lengthy recalculations based on a plurality of previous activities.

The periodicity of the determination of the members of an audience may depend on: a feature of the audience; a feature of the user; an activity and/or an event. For example, the determination of the members of an audience may be determined once a week as a matter of course (this may be defined in relation to the audience, where an appropriate periodicity may be determined by an operator and/or by an algorithm). The score may also be determined whenever a user has completed a jog (e.g. when it is determined that a user has entered and then exited a “jogging” context). The score may also be determined based on an input from an external party (e.g. an advertiser may request the audience is updated before an advertising campaign commences). It will be appreciated that each of these updating methods may affect different users: the memberships of all users may be updated once a week; the membership of the single user only may be updated following an activity (a jog); the membership of only the users already in the audience may be updated following the event.

Typically, the determination of the members occurs at least monthly, at least weekly, and/or at least daily.

As mentioned, the determination of the members of an audience may occur based on an event; the passage of a certain period; and/or an activity being completed. This determination of membership may be performed: for all users; for the users in the audience; for the users not in the audience; and/or for a subset of users associated with an activity that has been completed.

The memberships of a user may be determined based on a single device and/or a plurality of devices. In some embodiments, memberships are determined on a device-by-device basis where this can minimise the transmission of personal information. For example, devices may be placed into audiences, where the users of these devices are entirely unknown.

Alternatively, devices may be associated due to a shared user (or a similarity between users). For example, if a user has one mobile phone for work use and one for personal use, the data that originates from these devices can be merged together. Examples of ways this can be achieved include:
Amalgamating the data by examining the timestamps attributed to each event, and computing audiences/memberships from the resulting data. This can be implemented on either on one of the originating devices, or on a third device.
Computing audiences/memberships independently on each device, and combining the memberships via a set-wise union, intersection, or some other operation, either on one of the originating devices, or on a third device. For example, a first device may determine that a user is a “jogger” and a “workaholic” and a second device may determine that a user is a “jogger” and a “night owl”; these memberships may then be merged to determine that the user is a “jogger”, a “workaholic” and a “night owl” (and the data used to determine these memberships need not be shared between the devices).

In some embodiments, membership of a first audience is dependent on membership of a second audience. This dependency may comprise: membership of the second audience being required for membership of the first audience; membership of the second audience precluding membership of the first audience; and/or membership of the second audience altering a threshold for membership of the first audience.

In some embodiments, a user may be defined as an expected member of an audience and/or a likely member of an audience. This may affect the confidence of a user being placed in a audience. Equally, the regularity of the updating of a membership for a first audience may depend on a user's membership of a second audience. As an example, a user that is a “jogger” and a “night owl” may be expected to become a “night jogger”; therefore, while the memberships of this user may be updated weekly for most audiences, the membership of this user for the “night jogger” audience may instead be checked/updated daily.

Equally, the user may be determined to be a limited member of the “night jogger” audience, where the user has not fulfilled the usual requirements for membership of this audience, but the user is nevertheless associated with this audience due to membership of other audiences. There may be a distinction between full members of an audience and limited members of that audience, where a company targeting “night joggers” might be able to decide whether to target all members or whether to target full members only. In practice, this distinction is typically made by reference to a confidence score of the users, where users that do not fulfil all of the usual requirements for membership are typically associated with a lower confidence score.

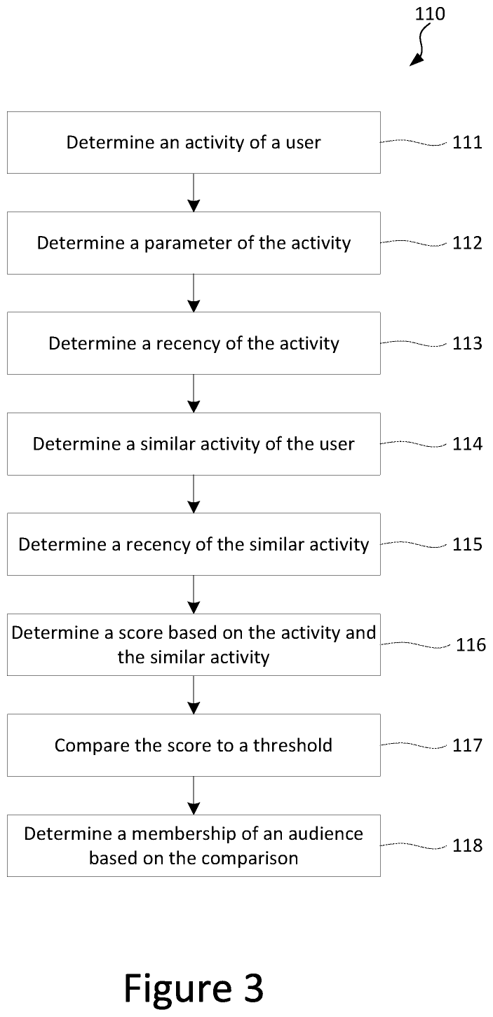

Referring to FIG. 3, there is shown a detailed exemplary method 110 of placing a user in an audience. It will be appreciated that any of the below steps can be implemented in any combination (these features are not inextricably linked). This method may be implemented using the computer device 1000 (e.g. the computer device of a user and/or the central server 1000-3 comprising information relating to a plurality of users).

In a first step 111, the computer device 1000 determines an activity of a user. Typically, this comprises determining a context of a user, where the entry into and/or exit from this context may be determined along with features of the activity performed in this context. With the example of jogging, the user may be determined to be in a “jogging” context based on a heart rate, GPS data, and/or the opening of a run-tracking application. An exit from the “jogging” context may be based on similar sensor data (e.g. when the user arrives at a GPS location associated with their home).

In a second step 112, the computer device 1000 determines a parameter of the activity. For example, a high heart rate may indicate strenuous jogging, while GPS data may indicate a jogging distance, and a time between entry and exit of the context may indicate a jogging duration. In a basic implementation, the parameter may simply be the performance of the activity (e.g. the entry into the “jogging context”), where this parameter then indicates that the user has gone jogging on a certain date.

In a third step 113, the computer device 1000 determines a recency of the activity. This may be on the order of seconds, minutes, hours, days, weeks, or months. Equally, this recency may be a qualitative assessment related to, for example, an expected interval between similar activities.

In a fourth step 114, the computer device 1000 determines at least one other similar activity of the user. In a fifth step 115, a recency of this other activity is determined. For example, a previous jogging activity may be identified along with a date associated with this previous jogging activity. This may comprise determining a plurality of previous similar activities.

Typically, the determination of a similar activity and the determination of the recency of this activity comprises determination of a previous score relating to performance of the similar activity. Therefore, instead of identifying a plurality of previous jogging activities, the method may comprise determining a previous score associated with the plurality of previous jogging activities. This enables repeated updates of the score without requiring a full recalculation each time.

In a sixth step 116, the computer device 1000 determines a score based on the activity and the similar activity. Typically, the determination of the score involves taking into account the recency values for each activity. In particular, more recent activities are typically given a greater weighting for the determination of the score.

In a seventh step 117, the computer device 1000 compares the determined score to a threshold. As has been described above, typically this is a threshold associated with membership of an audience. This threshold may be dependent on a plurality of activities and parameters (e.g. the threshold may depend on a number of activities, a magnitude of the activities, and/or a distribution of the actives).

In an eighth step 118, the computer device 1000 determines a membership of an audience based on the comparison. This may comprise a user being placed in an audience if the score exceeds a threshold and/or a user being removed from an audience if the score is below a threshold. The thresholds for being placed in an audience and for being removed from an audience may differ.

As described above, the method 110 of FIG. 3 may be performed: regularly, infrequently, periodically (e.g. once a week); based on an event (e.g. when a “jogging” context is identified) and/or based on an operator input (e.g. when a third party wishes to identify “joggers”).

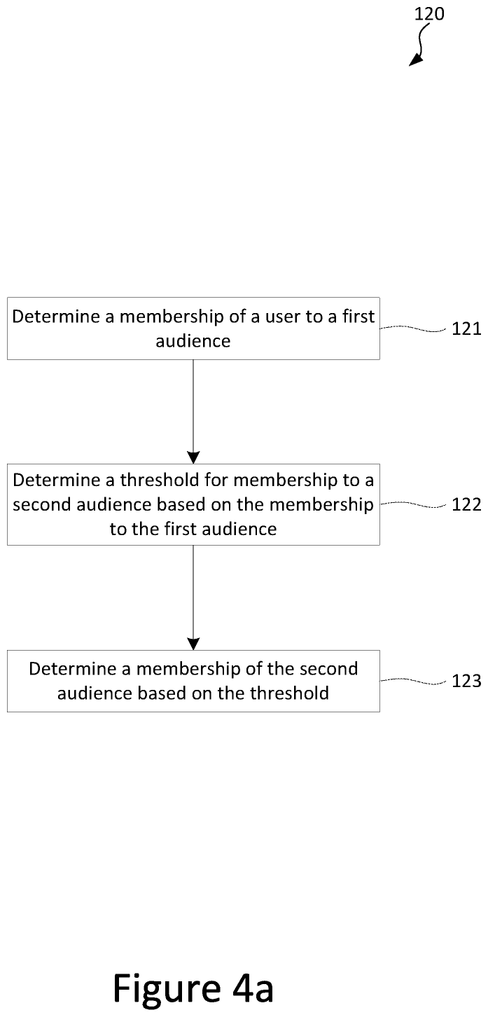

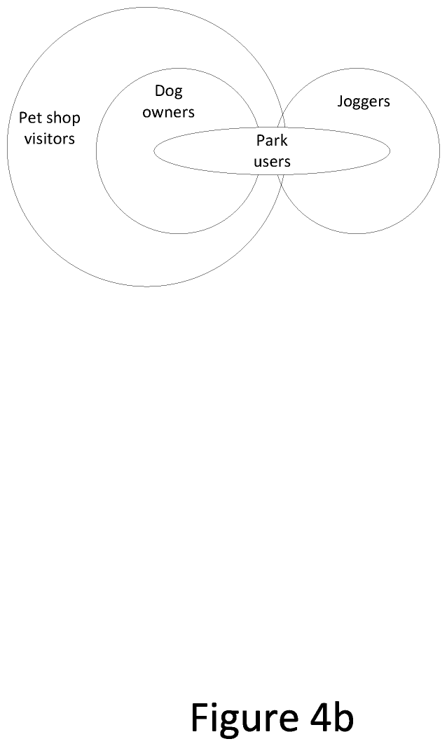

Referring to FIG. 4a, there is shown an exemplary method 120 of determining membership of a user to a second audience based on a membership of that user to a first audience. This method may be implemented using the computer device 1000 (e.g. the computer device of a user and/or the central server 1000-3 comprising information relating to a plurality of users).

In a first step 111, a membership of a user to a first audience is determined. In a second step 112, a threshold for membership to a second audience for the user is determined based on the membership to the first audience. In a third step 113, a membership of the second audience is determined based on the threshold. This typically comprises determining whether the user should be placed into the second audience or determining whether the user should be removed from the second audience.

In a simple example, a user who is a “morning jogger” may be automatically placed in the “jogger” audience (where the threshold for entry to this “jogger” audience is set as a score of 0 for the user).

The threshold may depend on: a plurality of other memberships of the user; a likelihood score relating to those other memberships; a liveness score relating to the other memberships; and a recency score relating to those other memberships.

A usage of the method 110 of FIG. 4a is shown by FIG. 4b. In this example, it can be seen that:
all “dog owners” are “pet shop visitors”;
very few “pet shop visitors” are “joggers”; and
almost all “park users” who are not “dog owners” are joggers.

Therefore:
The membership threshold for a “dog owner” to also be a “pet shop visitor” may be very low or this membership may be automatic. For example, if the ownership of a dog is determined based on an application downloaded by a user, this user may be added to both of the “dog owners” and “pet shop visitors” audience.
The membership threshold for a “pet shop visitor” to also be a “jogger” may be relatively high. In practice, a user that is not a “pet shop visitor” may need to go jogging three times a week on average to be deemed a “jogger”, whereas a user that is a “pet shop visitor” may need to go jogging five times a week on average to be deemed a “jogger”.
The membership threshold for a “park user” who is not a “dog owner” to be a “jogger” may be relatively low. For example, a user that is in the “park users” audience but not the “dog owners” audience may only need to go jogging once a week to be placed in the “joggers” audience.

Such a method enables rapid and accurate categorisation of users based on limited data. With the examples above, a park user who does not own a dog is very likely to be a jogger, but it may be hard to determine this based on sensor data alone. For example, this user may leave their phone at home when they go jogging. By identifying the other memberships of this user, it can be determined that this user is likely a jogger and so activities that suggest jogging may be given more emphasis (e.g. a higher score) than they would be otherwise.

While this method describes the alteration of a threshold for membership of a first audience based on membership of a second audience, it will be appreciated that equally the threshold may be constant and the activity scores of a user (that are used to determine membership of the first audience) may be modified based on the membership of this second audience. This achieves the same effect in the same way.

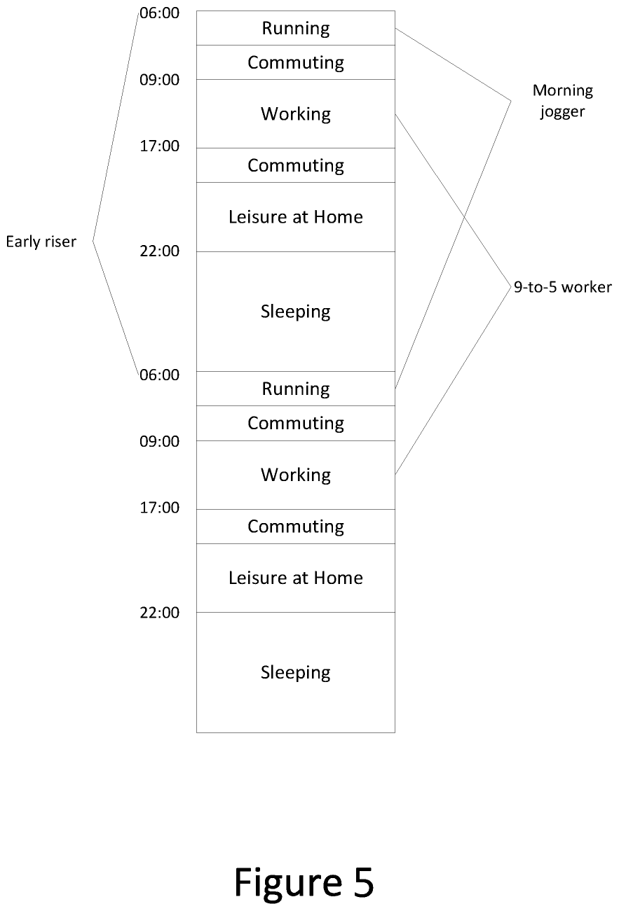

Referring to FIG. 5, there is shown an exemplary schedule of a user and a method of determining audience memberships based on this schedule.

At each point in the schedule, the context of a user may be inferred from sensor data. For example, jogging may be determined based on a heart rate; commuting may be based on a location; and working may be based on a mixture of location, and heart rate (e.g. whether the user is sitting down).

These contexts are used to determine membership of the various audiences. For example, the user can be determined to be a morning jogger since he goes jogging at 6:00 every morning. Typically, each audience has a related threshold; for example, the threshold for being a “morning jogger” may relate to one or more of: going jogging a certain number of times per week or per month; undertaking jogs of a certain duration, distance, and/or intensity; prioritising jogs over other activities. It will be appreciated that some combination of these requirements may be implemented, as has been described above. For example, each jog undertaken by a morning jogger may be given a score based on the distance, start time, and recency of the jog, where the scores for a plurality of jogs can be combined and compared to a threshold relating to membership in a “morning jogger” audience.

Furthermore, as has been described above, the threshold for membership may depend on a characteristic of the user such as a cultural background or a country of residence. In this regard, the number of jogs required per week to join the “morning jogger” audience may be higher in countries with a more active population.

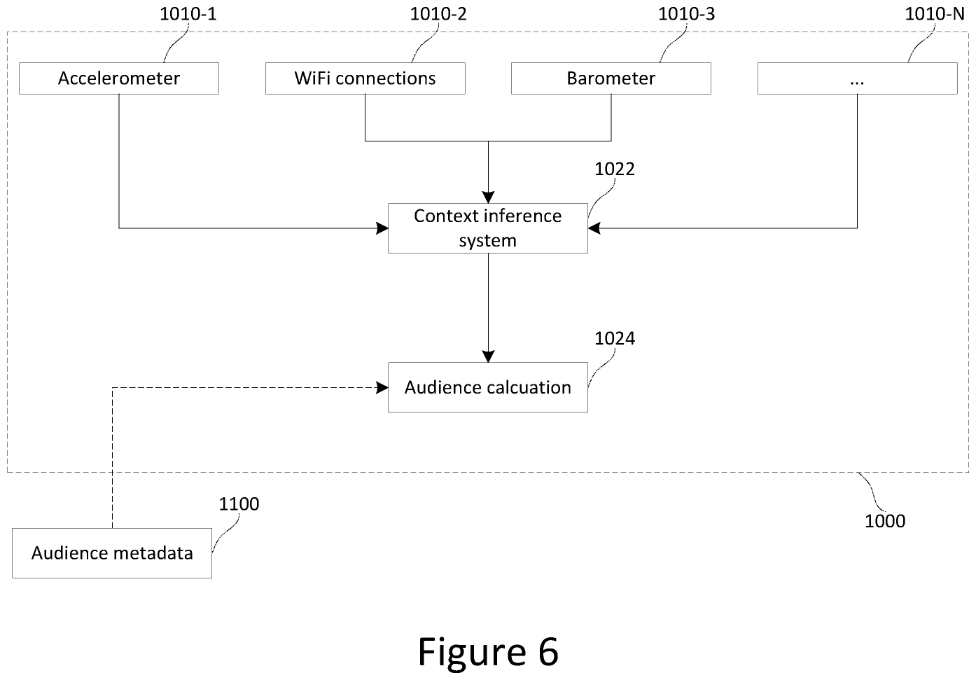

Referring to FIG. 6, there is shown an exemplary system on which the methods disclosed herein may be implemented.

This system comprises the computer device 1000. The computer device comprises a plurality of sensors 1010-1, 1010-2, 1010-3, 1010-N. These sensors include: an accelerometer 1010-1; a sensor for detecting WiFi connections 1010-2; and a barometer 1010-3.

The sensors 1010-1, 1010-2, 1010-3, 1010-N feed into a context inference system 1022 that is arranged to infer contextual information from sensor data. For example, the context inference system may determine an activity state of a user (e.g. “stationary”, “jogging”, “football”, “heavy exercise”, etc.) from the accelerometer and from a heart rate sensor.

Typically, the context inference system 1022 is implemented using the CPU 1002 of the computer device 1000.

Exemplary context types are shown in the table below

| Context Type | Examples |
|---|---|
| Activity | Stationary, Walking, Running, Cycling, |
| | Bicycle, Bus, Car, Motorbike, Subway, |
| | Train, Tram, Boat |
| Indoor/Outdoor | Indoor, Outdoor, Enclosed |
| Place | Home, Work, Academic, Entertainment, |
| | Food & Drink, Office, Recreational, |
| | Residential, Shops & Services |
| Situation | Housework, Leisure, Morning Rituals, |
| | Shopping, Sleeping, Social, Travelling, |
| | Working, Working Out |
| (Relative) Heart Rate | Resting, Elevated, Maximum |
| Heart Rate Variability | Low, Medium, High |
| People Presence | Yes/No, Number of people nearby |
| Stress | Low, Medium, High. Quantitative values |
| Mood/state of mind | Valence, Arousal, Dominance |
| Connected Devices | Wired Headphones, Wireless Headphones |

The computer device 1000 further comprises an audience calculation module 1024. The audience calculation module determines the audiences to which the computer device and/or the user of the computer device belongs. Typically, this comprises placing the user into (and/or removing the user from) audiences based on the contextual information determined for the user. The audience calculation module is typically implemented using the CPU 1002 of the computer device.

The audience calculation module 1024 may receive audience metadata from an external audience metadata module 1100. This audience metadata module may comprise an external server that provides audience metadata to the computer device 1000 via the communication interface 1004 of the computer device.

Typically, the audience metadata comprises one or more of: a definition of an audience; a threshold score for an audience; and a characteristic of an audience. The audience metadata may be determined solely on the computer device 1000 of the user; solely on an the external audience metadata module 1100; and/or on a combination of the computer device of the user and the audience metadata module.

In embodiments where the threshold for membership is dynamic so as to maintain a certain number or fraction of users in an audience, the audience metadata may comprise an indication of a current threshold and/or information that enables the computer device 1000 to determine the threshold.

In this way, the computer device 1000 can receive audience metadata about: the requirements and/or thresholds for membership of an audience; information about the membership statistics of an audience (e.g. how many users are already in that audience); and connections between audiences (e.g. the effect that membership of a first audience has on the threshold for membership of a second audience). This audience metadata may be determined based on operator-input rules and/or based on supervised and/or unsupervised learning and may be based on the activities of a plurality of users.

The audience calculation module 1024 can then determine memberships for the user and/or the computer device based on this audience metadata and user/device information. This enables the user to be placed in appropriate audiences without the need to transmit personal information from the device, which may raise concerns about confidentiality/privacy. These audience memberships may then be transmitted to another device (e.g. to the central server 1000-3), where the server may be told that a user is a “jogger” without knowing why this assessment has been made. Equally, the audience memberships may remain on the device. Where audience memberships are kept on a device, a third party may be able to send a communication to a plurality of devices, for example a communication stating “warn joggers about smog”. The method may then include outputting a message to a user based on the memberships of a user and a communication from an external device, where the CPU 1002 of the device is able to process the incoming communication and to only show the communication to the user of the device if the user/device is a member of the “jogger” audience.

In some embodiments, membership of an audience is determined on a device-by-device and/or an application-by-application basis. Therefore, the computer device 1000 may determine that a device is used by a jogger without access to any personal information (e.g. name etc.) of that jogger. The device may make this determination based on, for example, accelerometer and GPS data.

An exemplary use of the audience memberships is for targeted advertising. For example, an advertiser may request audience information from a device; this advertiser may then receive an indication of audiences to which the device belongs and in response provide customised advertising for this device.

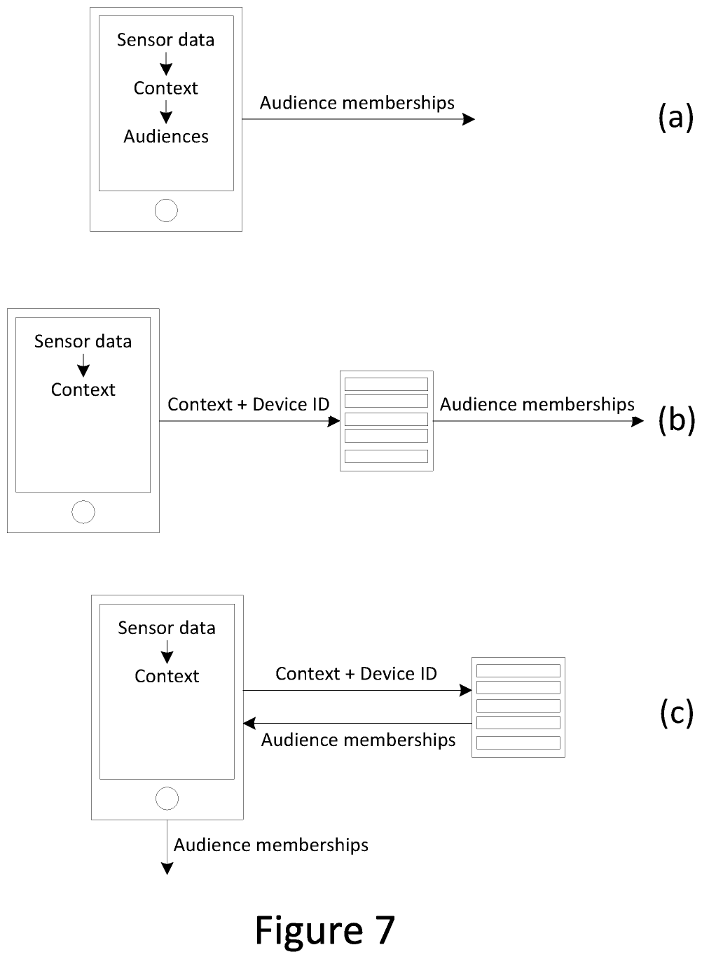

Referring to FIGS. 7a-7c, options for the determination and sharing of memberships to audiences are shown.

Referring to FIG. 7a, as has been described above, audience memberships may be determined entirely on a single computer device. This may comprise the thresholds for membership of audiences being determined on the device, but typically comprises the thresholds being provided to the device by a further computer device.

Referring to FIG. 7b, the audience memberships may be determined by the central server 1000-3 based on context data received by a device. Typically, this context data is associated with a device identifier (as opposed to a user identifier). This enables the audience memberships to be determined without accessing personal user information. These audience memberships can then be transmitted from the server to further devices (e.g. third party devices).

It will be appreciated that in some embodiments, device identifiers may be linked to user identifiers so that, for example, context data from a plurality of devices owned by a single user is considered together. For example, where a user has a personal phone and a work phone, information may be collected from each of these phones and combined. In a practical example, a work device may determine the times during which a user is at work and a personal device may determine the times during which a user is sleeping; these pieces of contextual information may be combined on either the work device, the personal device, or a third device and then the combined information can be used to determine membership information for the user.

Equally, memberships may be determined on a plurality of devices of a user and these memberships may then be combined. This enables the sharing of membership data without the need to share the personal/contextual information used to obtain the membership data. The shared membership data may, for example, comprise an indication of audiences of which the user is a member, an indication of a likelihood of a user being a member of an audience, and/or an indication of liveness.

Memberships shared from a plurality of devices may, for example, be combined using a ser-wise union or an intersection.

Referring to FIG. 7c, the system may comprise the user device and the server device where the server device is arranged to determine the audience memberships of the user device and then to provide these memberships back to the user device from where the membership information can be forwarded to other devices. This enables the user to control the sharing of audience memberships to third party devices.

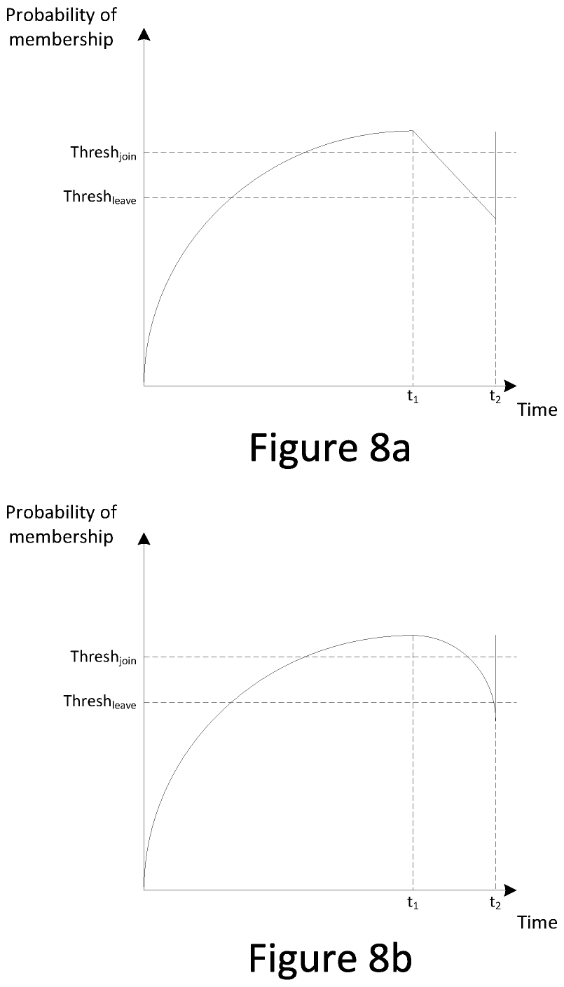

Referring to FIGS. 8a and 8b, as described above the membership of a user in an audience may be based off a threshold. As described above the threshold for joining an audience (Threshⱼₒᵢₙ) may be different to the threshold for leaving an audience (Threshₗₑₐᵥₑ)—equally, these thresholds may be the same.

Referring to FIG. 8a, the score for a user at a time t₁ is dependent on activities performed by a user up to this time t₁. The membership of a user at the time t₁ may thus be determined based on this score (e.g. based on whether or not this score exceeds a threshold).

Typically, the score of a user (or the score of an activity of a user) is arranged to decay following the performance of that activity. This can be seen in FIGS. 8a and 8b. This decay may, for example, be a linear decay as shown in FIG. 8a, or an exponential decay as shown in FIG. 8b.

When the user performs another relevant activity (e.g. at time t₂), the score is recalculated and the membership of the user redetermined.

The redetermination of the score may comprise a recalculation based on a plurality of relevant activities. However, typically, a first score calculated at a first time is arranged to decay until the performance of another relevant activity at a second time. At the second time, a second score can be determined based on the first score, a decay function, and the other relevant activity. This avoids the need to completely recalculate scores.

As well as membership of an audience, a score may be used to determine a probability (e.g. confidence) of membership, where the thresholds for joining and/or leaving the audience may be associated with a probability. This probability may, for example, relate to how often a user performs an activity, or for how long a user performs an activity.

As has been described above, the determined audiences may be transmitted between devices; for example, the audiences may be transmitted from one of the user devices 1000-1, 1000-2 to the central server 1000-3 and/or vice versa.

Problematically, knowledge of the audiences of a user may enable a party to determine the identity of that user or to determine aspects of the context data or user information used to determine the audiences. Therefore, the sharing of audiences may lead to decreased data security. As an example, a malicious party may be able to use the audiences of a user to determine aspects of a user's routine and interests, which may enable that malicious party to access the user's data.

Therefore, in some embodiments, the computer device 1000 (e.g. the user device 1000-1, 1000-2 and/or the central server 1000-3) is arranged to only transmit a subset of the audiences of a user to another device. For example, the computer device may be arranged to transmit no more than 5 audiences, no more than 3 audiences, and/or no more than 2 audiences.

Typically, a first computer device transmits a request for audiences to a second computer device. The second computer device may then transmit the limited number of audiences to the first computer device. The number of audiences may depend on one or more of: the requesting computer device; the transmitting computer device; an owner associated with one or more of the devices; a number of previous requests and/or transmissions associated with one or more of the devices.

The computer device 1000 may be arranged to determine a plurality of related audiences, where these related audiences indicate a characteristic of an associated user. More specifically, the computer device may be arranged to determine a set of audiences for a user, where the set of audiences comprises one or more audiences associated with the user.

In some embodiments, audience memberships are determined on the user device 1000-1, 1000-2 and are stored on the central server. In such embodiments, the user device may be arranged to transmit only a set of audiences to the central server (e.g. a bigram of audiences), where this increases data security by preventing the central server from determining user information (since the user device only transmits a set of audience memberships for a user as opposed to the entirety of the audience memberships of the user).

Typically, the sets of audiences are determined on, and/or transmitted to, the central server 1000-3, where the central server is able to transmit the sets of audiences to other device without compromising the security of user data. The sets of audiences may be encoded so as to not reveal any of the constituent audiences of that set (e.g. the vectors of the constituent audiences may be combined so that only a combined vector is transmitted).

Where a significant number of sets of audiences (n>>2) are known, the sets of audiences may be used to determine lookalike audiences, and/or lookalike sets, to which the user is likely to belong. Typically, the server is arranged to receive such a large number (e.g. all) of the sets of audiences associated with a user so that the server can determine lookalike audiences. Other devices may only receive a small number of sets (from either the server or another device) so as to increase data security.

Determining the lookalike audiences may comprise using a regression model, whereby the audiences (or sets) associated with a user are plotted in a vector space and a regression model is used to determine likely sets of audiences to which the user belongs based on a correlation of these likely audiences to the actual audiences in the vector space.

In some embodiments, the determination of the lookalike audiences and/or lookalike sets of audiences comprises the computation of conditional probabilities associated with the audiences and/or the potential sets of audiences. The computer device 1000 may be arranged to determine a probability and/or a frequency of one or more sets of audiences (e.g. to determine how many users are associated with each possible set of audiences). The determination may comprise the construction of a Bayesian Network and/or the examination of mutual information coefficients.

In some embodiments, the computer device 1000 is arranged to determine a set of audiences for transmission to another device. For example, the computer device 1000 may determine that a certain set of audiences is rare and may therefore determine that this set of audiences is a good indicator of a user. Equally, the computer device may determine that a certain set of audiences is a particularly good indicator of a certain user characteristic and may therefore determine that this set of audiences should be transmitted in response to a request. Typically, the computer device is arranged to determine a set of audiences for transmission based on this set being a common set (i.e. where many users belong to this set) so as to increase data security and to prevent the identification of a user from a specific set of audiences. The determination of the set of audiences may be random and/or may depend on one or more of: the requesting device, the user, the transmitting device, and previous requests associated with the user and/or the requesting device (e.g. the computer device may determine a set of audiences that has previously been transmitted to another device and re-send this set in response to a subsequent request to ensure that a single device cannot obtain all user audiences by making repeated requests).

In some embodiments, the computer device 1000 is arranged to receive a request from another device and to determine a set of audiences in dependence on this request.

In some embodiments, the computer device 1000 is arranged to determine sets of audiences (e.g. sets of at least 2 audiences, at least 3 audiences, and/or at least 5 audiences). This both increases data security and decreases the amount of storage space needed to store the audience information (as compared to an implementation in which audience memberships are stored separately). In this regard, where there are a total of K possible audiences, storing all possible combinations of audiences would require 2^{K} rows. In contrast, storing a plurality of sets of maximum size N (that is maximum N audiences per set) only requires

$$( \begin{matrix}K \\ 0\end{matrix} ) + ( \begin{matrix}K \\ 1\end{matrix} ) + ( \begin{matrix}K \\ 2\end{matrix} ) + … + ( \begin{matrix}K \\ N\end{matrix} )$$

rows, where

$$( \begin{matrix}K \\ B\end{matrix} )$$

denotes the number of B-sized subsets of a set of size K. For small N relative to K, this required storage is much less than 2^{K}. Typically N/K is no greater than 0.2, no greater than 0.1, and/or no greater than 0.05.

The computer device may be arranged to transmit at most one of the sets (where this set is an indication that a user is present in one or more audiences).

The transmission of the set may comprise the transmission of an identifier, or indicator, relating to the set. Where there are ten possible audiences, and a maximum set size of two audiences per set, there are 56 possible sets of audiences to which a user may belong. Therefore, a six digit binary string can be used to indicate each of the sets to which a user belongs. Using such an indicator avoids the need to indicate separate user memberships to a device requesting audience information. In practice, the computer device 1000 may receive an audience request from a further device and in response transmit the indicator to the further device so that the further device can determine a set of audiences associated with the user. The further device may be able to access (e.g. via the server) a database that associates indicators with sets of audiences (so that, for example, the further device may be able to associate an indicator 011001 with memberships of Audiences A and B). Equally, the further device may not be able to determine the component audiences from an indicator. In this regard, servicers (e.g. advertisements) may be tailored for a user based on the indicator of the set without the further device being aware of the component audiences of that set (so that, for example, the further device may be able to identify suitable advertisements for a user based on the indicator 011001). For example, the server may store a database that indicates a meaning of each set (e.g. set 011001 may indicate a love of pets without indicating specific audience memberships).

In some embodiments, the computer device is arranged to determine a lookalike audience or set based on the set and/or the audiences within the set. In this regard, the computer device may determine a likely set for the user based on a determined set, and this likely set may be transmitted in response to the request. This further increases data security by preventing the reverse engineering of user data.

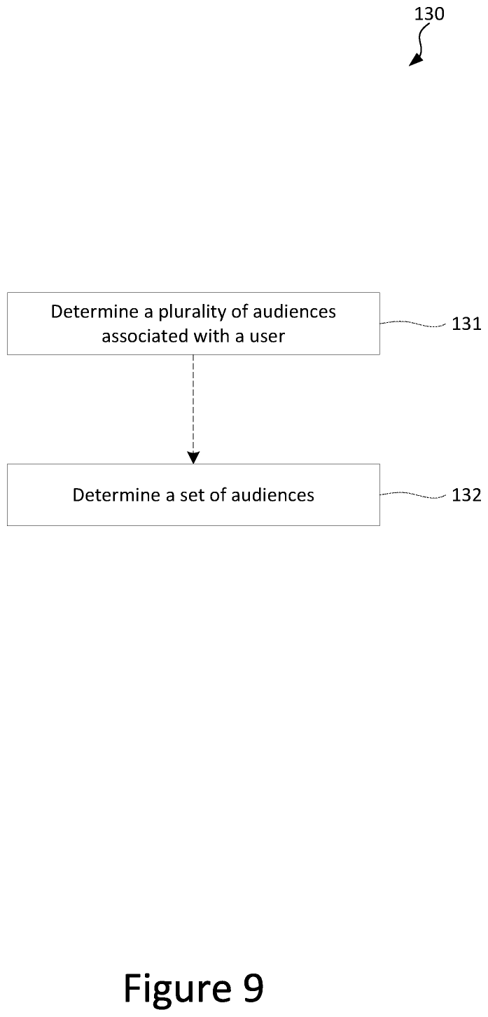

FIG. 9 shows a method of determining a set of audiences.

In a first step 131, the computer device 1000 determines a plurality of audiences associated with a user (e.g. using one of the methods described above). In a second step 132, the computer device determines a set of audiences, e.g. using a regression model.

### Alternatives and Modifications

It will be understood that the present invention has been described above purely by way of example, and modifications of detail can be made within the scope of the invention.

For example, while the detailed description has primarily considered methods that avoid the need to transfer personal information away from a device, these methods may equally be arranged to avoid the need to transfer information away from an application on a device. For example, the audience metadata may be provided to an application on a device such that this application can determine appropriate audiences for the user/device. Therefore, separate applications on the same device may be arranged to not share personal information.

In various embodiments, information about audiences and/or memberships may be: transmitted from a first user device (e.g. a user's device) to a second user device; output to a user and/or a device; used in the determination of a warning and/or an output (e.g. a warning and/or an output may be determined in dependence on an audience and/or a membership).

In some embodiments, users are not placed into or removed from audiences, but instead users are associated with a plurality of audiences based on a probability of being in a member of that audience.

The methods and systems disclosed herein may be implemented using a sensor hierarchy, e.g. as described in WO 2020/201778. In particular, a user and/or a device may subscribe to a node of a hierarchy in order to receive information from this node and from each descendent node (e.g. child nodes etc.) in the hierarchy. The use of such a sensor hierarchy may be used to determine contextual information based on which memberships can be determined. This provides the user with further control over the types of contextual information that are shared.

As an example, a node in the hierarchy may be arranged to determine an activity of the user (e.g. based on an accelerometer and a gyroscope the user may be determined to be running). Similarly, a node may determine a location of a user (e.g. based on the presence of ambient light and a GPS signal strength, the user may be determined to be outdoors). Also similarly, based on the activity and the time or location, a context may be determined (e.g. jogging). This context can be used to determine the audience membership.

Therefore, the context may be determined using a hierarchical arrangement of nodes/sensors (including virtual sensors) on the computer device 1000. In particular, a situation may be determined based on an activity, where the ‘activity’ node is lower in the hierarchy than the ‘situation’ node.

Typically, the activities of the user are determined based on contextual information and/or sensor data from a plurality of devices. Examples of the sharing of information, and the determination of contextual information from sensor data, are described in WO 2020/201777. The sharing of information and/or contextual information may depend on the permissions of one or more devices, where these permissions may relate to types of data and/or contextual information that each device may receive, share, and/or access. For example, the smartphone of a user may be able to share only certain types of data (e.g. GPS data) and/or only certain types of contextual information (e.g. a qualitative location of the user). Typically, the permissions are dependent on a user input.

The activities of the user may then be determined based on the types of data and/or contextual information that a device of the user is allowed to receive and/or access.

Equally, a threshold for membership of an audience may be dependent on these types of data/contextual information. In this way, the threshold for membership of the audience may be dependent on the permissions of a user and/or a device. Equally, the annotations/ratings for the user and the audience (e.g. the confidence, strength, recency, and/or liveness) may be dependent on these permissions.

In a practical example, the smartphone of a user may have permissions to share (and/or access) contextual information relating to a qualitative assessment of a user's location (e.g. outside, at home, at a coffee shop) but not to share the underlying GPS data. Therefore, a device of the user that is determining the membership of the user in the jogging group may be required to determine this membership based on this qualitative assessment. The threshold for membership may be determined accordingly (e.g. this threshold may be lower than for other users, since it is likely that the device will not be able to identify every “jogging” activity). Due to this, the confidence rating for this user in the “jogging” audience may be low.

In some embodiments, the annotations/ratings for the user comprise a range (e.g. a mean value and error bounds). In embodiments that use a range for annotations, where a device of the user only has access to a limited amount or type of information this may lead to greater error bounds for the annotations/ratings.

Reference numerals appearing in the claims are by way of illustration only and shall have no limiting effect on the scope of the claims.

1. An apparatus for determining an output based on a membership of the user in an audience, the apparatus comprising:
a processor for:
determining a threshold associated with membership of an audience;
determining a score relating to a user in dependence on one or more activities of the user associated with the audience, wherein at least one activity is determined based on contextual information of the user; and
determining the membership of the user in the audience in dependence on whether the score exceeds the threshold; and
a user interface and/or a communication interface for providing an output for the user based on the membership of the user in the audience.

2. The apparatus of claim 1, comprising determining the contextual information, and/or determining the contextual information based on sensor data and/or determining sensor data using a sensor of the apparatus.

3. The apparatus of claim 1, wherein the processor is arranged to determine a recency of one or more of the activities; and to determine the score in dependence on the recency.

4. The apparatus of claim 1, wherein:
the processor is arranged to determine the score by scaling an existing score in dependence on a recency of the existing score; and/or
the processor is arranged to determine a scaling factor for each of the activities, wherein each scaling factor relates to the recency of the corresponding activities.

5. The apparatus of claim 1, wherein the processor is arranged to determine a confidence relating to the likelihood that the user should be a member of the audience, and/or wherein the processor is arranged to determine the confidence based on a permission of the apparatus, the permission relating to the contextual information that the apparatus is able to access.

6. The apparatus of claim 1, wherein the processor is arranged to determine a strength relating to the degree to which a user identifies with the audience.

7-8. (canceled)

9. The apparatus of claim 1, wherein the processor is arranged to determine whether the user should be placed into the audience and/or determine whether the user should be removed from the audience.

10. (canceled)

11. The apparatus of claim 1, wherein the processor is arranged to determine a component score for each activity, and/or wherein the processor is arranged to determine a component score for each activity in dependence on one or more of: a magnitude of the activity; a duration of the activity; a recency of the activity; a regularity and/or timing of the activity; and a priority associated with the activity.

12. The apparatus of claim 1, wherein the apparatus is arranged to determine a liveness relating to an audience, wherein the liveness relates to one or more of:
whether, and/or how recently, the user has previously performed an activity associated with the membership of an audience;
whether the user is currently performing an activity associated with the membership of an audience;
whether, and/or how soon, the user is expected to perform in the future an activity associated with the membership of an audience; and
a relevance of a further (e.g. recent) activity of the user to the audience.

13. The apparatus of claim 1, wherein the user interface and/or the communication interface is arranged to output one or more of: a confidence; a liveness; a notification in dependence on the membership; a notification that the user is a member of the audience; a targeted notification; and an advertisement for the user based on the membership.

14. The apparatus of claim 1, wherein:
the processor is arranged to determine the audience and/or the threshold in dependence on information received at the communication interface from a further apparatus; and/or
the processor is arranged to determine the audience and/or the threshold based on information from a plurality of apparatuses.

15. The apparatus of claim 1, wherein:
the communication interface is arranged to receive the audience and/or the threshold from a centralised server; and/or
the communication interface is arranged to receive audience information form a further apparatus, wherein the processor is arranged to determine the threshold and/or the audience in dependence on the audience information.

16. The apparatus of claim 1, wherein the processor is arranged to determine each activity based on information located solely on the apparatus.

17. The apparatus of claim 1, wherein the communication interface is arranged to transmit information relating to the membership to the further apparatus and/or a separate apparatus.

18. The apparatus of claim 1, wherein the communication interface is arranged to transmit one or more of: an indication that the user is a member of the audience; a threshold for membership of the audience; and an indication of the score.

19. (canceled)

20. The apparatus of claim 1, wherein the processor is arranged to determine the further membership of the user in a further audience; and to determine the threshold in dependence on the further membership.

21. The apparatus of claim 1, wherein:
the processor is arranged to determine a threshold for the user for the audience in dependence on a characteristic of the user; and/or
the threshold for membership of the audience is different for different users.

22. (canceled)

23. The apparatus of claim 1, wherein the processor is arranged to determine the threshold:
based on one or more of: a category of an application used by the user; a location of the user; a cultural and/or political identifier of the user; a seasonal characteristic; and/or a local event associated with the user; and/or
so as to maintain a certain number of users in the audience and/or a certain fraction of total users in the audience; and/or
in dependence on a recent change in the number of users in the audience; and/or based on a characteristic of one or more existing members of the audience; and/or
based on a characteristic of one or more existing members that exceed one or more of: a threshold confidence, a threshold strength, and a threshold liveness.

24-34. (canceled)

35. A method of determining an output for a user based on a membership of the user in an audience, the method comprising:
identifying a threshold associated with membership of an audience;
determining a score relating to a user in dependence on one or more activities of the user associated with the audience, wherein at least one activity is determined based on contextual information of the user;
determining the membership of the user of the audience in dependence on whether the score exceeds the threshold; and
providing an output for the user based on the membership of the user.

36. A system for determining an output for a user based on a membership of the user in an audience, the system comprising:
a first apparatus comprising:
a processor for:
determining a threshold associated with membership of an audience;
determining a score relating to a user in dependence on one or more activities of the user associated with the audience, wherein at least one activity is determined based on contextual information of the user; and
determining the membership of the user in the audience in dependence on whether the score exceeds the threshold; and
a user interface and/or a communication interface for providing an output for the user based on the membership of the user in the audience; and
a second apparatus comprising a communication interface for communicating with the first apparatus.

37-42. (canceled)
